(19) United States
(12) Patent Application Publication
(10) Pub. No.: US 2017/0291838 A1
(43) Pub. Date: Oct. 12, 2017

(54) WATER PURIFICATION APPARATUS USING SOLAR POWER

(71) Applicant: SEGI SYNTHETIC ENVIRONMENT CO., LTD., Jeonju-si Jeollabuk-do (KR)

(72) Inventors: Ki Hae YANG, Jeonju-si (KR); Byoung Soon SONG, Jeonju-si (KR)

(73) Assignee: SEGI SYNTHETIC ENVIRONMENT CO., LTD., Jeonju-si Jeollabuk-do (KR)

(21) Appl. No.: 15/353,920

(22) Filed: Nov. 17, 2016

(30) Foreign Application Priority Data
Apr. 6, 2016 (KR) 10-2016-0042134

(51) Int. Cl. C02F 3/20; C02F 3/00; C02F 1/52

(52) U.S. Cl. CPC C02F 3/208; C02F 1/52; C02F 3/006; C02F 2203/006

(57) ABSTRACT

A water purification apparatus includes a flow-rate regulating tank, an aeration tank, a solar power generation unit, and an air blowing unit. The flow-rate regulating tank changes flow-rate of polluted fluid to constantly discharge. The aeration tank purifies the fluid using microorganisms by contacting the polluted fluid supplied from the flow-rate regulating tank to an air, and includes a floatable panel supporting part and a purifying part connected under the panel supporting part to purify the polluted fluid. The solar power generation unit is supported by the panel supporting part to generate electric power using sunlight. The air blowing unit receives the electric power from the solar power generation unit to supply the air in the aeration tank.

### CROSS-REFERENCE TO RELATED APPLICATION(S)

This application claims priority to Korean Patent Applications No. 10-2016-0042134, filed on Apr. 6, 2016 in the Korean Intellectual Property Office (KIPO), the contents of which are incorporated herein in its entirety by reference.

### BACKGROUND

1. Technical Field

Example embodiments relate generally to a water purification apparatus. More particularly, embodiments of the inventive concept relate to a water purification apparatus using a solar power which is mounted in a position requiring water purification such as a wastewater treatment plant, a lake or a river, a reservoir, marine, a marine farm, a multi-purpose dam, etc., to purify water by operating the water purification apparatus using an electric power stored by solar power generation.

2. Description of the Related Art

In coastal marine, a lake, a river, a reservoir, etc., eutrophication is generated by inflow and storage of excessive organic material.

Thus, a water purification device including a flow-rate regulating tank and an aeration tank is actively researched. In the aeration tank, active sludge such as aerobic bacteria is supplied again from a settling tank and air is supplied by air blowing, so that polluted water in the aeration tank may be purified. Thus, an air blowing unit is required to supply air including oxygen in the aeration tank.

However, since the air blowing unit is operated by electric power, a lot of electric power is required to purify a lot of polluted water in a large sized aeration tank.

Thus, a water purification device, which is capable of generating electric power to drive the air blowing unit, is required.

### SUMMARY

Some example embodiments provide a water purification apparatus using a self-powered structure by a solar power generation and purifying water.

According to some example embodiments, a water purification apparatus includes a flow-rate regulating tank, an aeration tank, a solar power generation unit, and an air blowing unit. The flow-rate regulating tank changes flow-rate of polluted fluid to constantly discharge. The aeration tank purifies the fluid using microorganisms by contacting the polluted fluid supplied from the flow-rate regulating tank to an air, and includes a floatable panel supporting part and a purifying part connected under the panel supporting part to purify the polluted fluid. The solar power generation unit is supported by the panel supporting part to generate electric power using sunlight. The air blowing unit receives the electric power from the solar power generation unit to supply the air in the aeration tank.

In example embodiments, the purifying part may include a media bio-membrane connected to a lower part of the panel supporting part and including a media.

In example embodiments, the purifying part may include carbon fiber purifying the polluted fluid using the carbon fiber.

In example embodiments, the air blowing unit may include an air supply line prepared under the aeration tank to supply the air; and a discharge nozzle connected to the air supply line to discharge the air on an upper portion of the aeration tank.

In example embodiments, the water purification apparatus may further include a global positioning system (GPS) installed on the supporting part to check position of the supporting part; a solar tracking apparatus calculating semester, date, time, longitude, and latitude based on position information of the supporting part received from the global positioning system; and a propelling body installed on the supporting part to change position and direction of the supporting part based on position of the sun calculated by the solar tracking apparatus.

In example embodiments, the panel supporting part may include a plurality of unit bodies. Each of the unit bodies may include hexagonal faces including vertical flat surfaces connected with each other in a vertical direction; a module panel supporting part formed on the hexagonal faces to support the solar battery module; a first combining part formed to have a protrusion or a recess on the hexagonal faces; a second combining part formed under the hexagonal faces in an opposite shape to the first combining part to be combined with the first combining part; and a plurality of combining protrusions protruded from each of edges between the hexagonal faces in a horizontal direction perpendicular to the vertical direction. The combining protrusions may be disposed on recess grooves inwardly recessed from the edges, respectively.

In example embodiments, the water purification apparatus may further include a settling tank connected to the aeration tank to precipitate a portion of the purified fluid supplied from the aeration tank, and wherein the settling tank may supply active sludge to the aeration tank.

In example embodiments, the water purification apparatus may further include a vegetation structure disposed in the flow-rate regulating tank, the aeration tank, or the settling tank, and floatably stacked to grow vegetation.

The water purification apparatus of the present invention includes the solar generation unit, so that the air blowing unit is operated by a self-power using the electric power charged by the solar power generation, and direction is changed based on position of the sun. Thus, efficiency of the solar power generation is excellent.

Also, the water purification apparatus of the present invention is capable of vegetation, and shape and size may be easily controlled by assemblage and dissemblage of a unit body.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a water purification apparatus according to one embodiment of the present invention.

FIG. 2 is a cross-sectional view illustrating a water purification apparatus according to one embodiment of the present invention.

FIG. 3 is a cross-sectional view illustrating one embodiment of a panel supporting part which supports a solar power generation unit of FIG. 1.

FIG. 4 is a cross-sectional view illustrating another embodiment of a panel supporting part which supports a solar power generation unit of FIG. 1.

FIG. 5 is a cross-sectional view illustrating unit bodies forming the panel supporting part of FIG. 3.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. Rather, these example embodiments are provided so that this disclosure will be thorough and complete, and will fully convey the scope of the present inventive concept to those skilled in the art. In the drawings, the sizes and relative sizes of layers and regions may be exaggerated for clarity. Like numerals refer to like elements throughout.

It will be understood that, although the terms first, second, etc. may be used herein to describe various elements, these elements should not be limited by these terms. These terms are used to distinguish one element from another. For example, a first element discussed below could be termed a second element without departing from the teachings of the present inventive concept. Also, a second element discussed below could be termed a first element without departing from the teachings of the present inventive concept. As used herein, the singular forms are intended to include the plural forms as well, unless the context clearly indicates otherwise.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). It will be understood that, although the terms first, second, third etc. may be used herein to describe various elements, these elements should not be limited by these terms. These terms are used to distinguish one element from another. Thus, a first element discussed below could be termed a second element without departing from the teachings of the present inventive concept. As used herein, the term “and/or” includes any and all combinations of one or more of the associated listed items.

Meanwhile, the terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

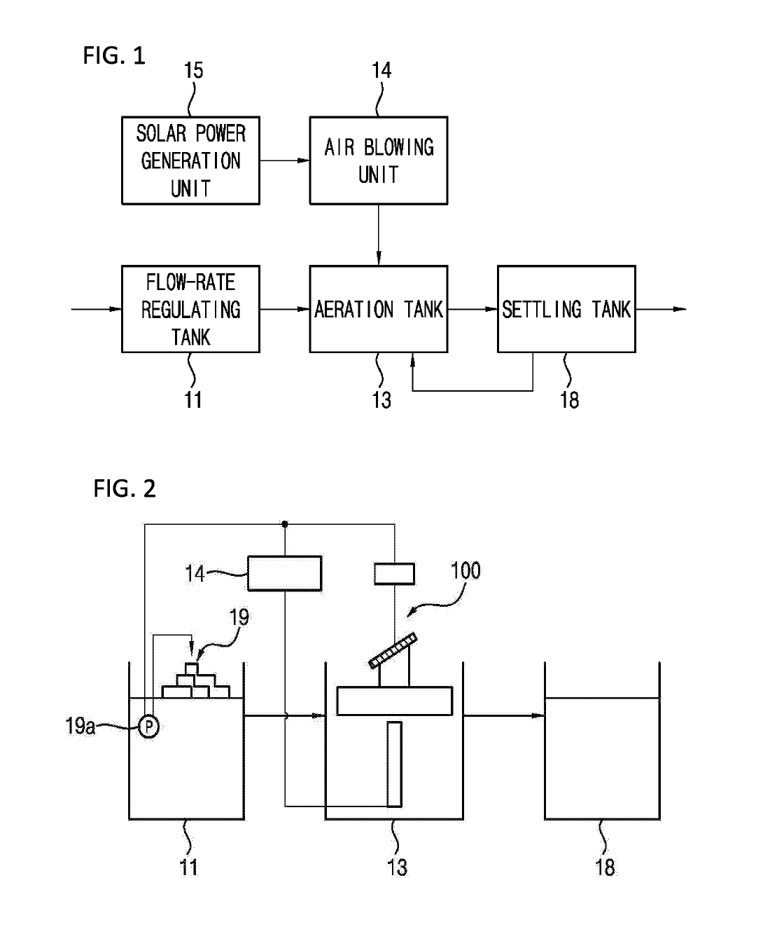

FIG. 1 is a block diagram illustrating a water purification apparatus according to one embodiment of the present invention. FIG. 2 is a cross-sectional view illustrating a water purification apparatus according to one embodiment of the present invention.

Referring to FIGS. 1 and 2, the water purification apparatus according to the embodiment of the present invention includes a flow-rate regulating tank 11, an aeration tank, a solar power generation unit 15, and an air blowing unit 14.

The flow-rate regulating tank 11 is prepared to control flow rate of polluted fluid to discharge the polluted fluid at a constant rate. The flow-rate regulating tank may supply the polluted fluid to the aeration tank 13 at the constant flow rate. An inlet (not shown) through which the polluted fluid is flow may be prepared on the flow-rate regulating tank 11, and a screen (not shown) which filters external impurities may be disposed under the inlet.

The aeration tank 13 is coupled with the flow-rate regulating tank 11. The aeration tank 13 may receive the polluted fluid discharged from the flow-rate regulating tank 11 to purify the polluted fluid. The aeration tank 13 receives air including oxygen from the air blowing unit 14 to purify the polluted fluid using microorganism.

The aeration tank 13 may receive active sludge including aerobic bacteria from the settling tank 18 to purify the polluted fluid. Thus, the aeration tank 13 may purify the polluted fluid through a standard activated sludge method.

Alternatively, the aeration tank 13 may purify the polluted fluid using a bio-membrane including microorganism included therein. Thus, the aeration tank 13 may purify the polluted fluid using a bio-membrane method.

The polluted fluid is purified using air including oxygen through the standard activated sludge method or the bio-membrane method, and thus, the aeration tank 13 is connected to the air blowing unit 14 which supplies the air in the aeration tank 13.

The aeration tank 13 is connected to a panel supporting part which is floatable and a purifying part connected under the panel supporting part to purify the polluted fluid.

The panel supporting part is prepared by fabricating a plurality of unit bodies to support the solar power generation unit thereon. Detailed description concerning the panel supporting part will be explained later.

The purifying part, for example, includes a media bio-membrane including media. The media which is capable of purifying the polluted fluid is prepared in the media bio-membrane. Thus, the purifying part may purify the polluted fluid in the aeration tank.

Meanwhile, the purifying part may include a purifying body on which carbon fiber is attached. Thus, the polluted fluid may be purified using aerobic bacteria attached to the carbon fiber.

Alternatively, the purifying part may have various shapes or types.

The solar power generation unit 15 is prepared on the panel supporting part. Thus, the panel supporting part may support the solar power generation unit 15. The solar power generation unit 15 generates an electric power using sunlight. Thus, the solar power generation unit 15 may supply the electric power to the air blowing unit.

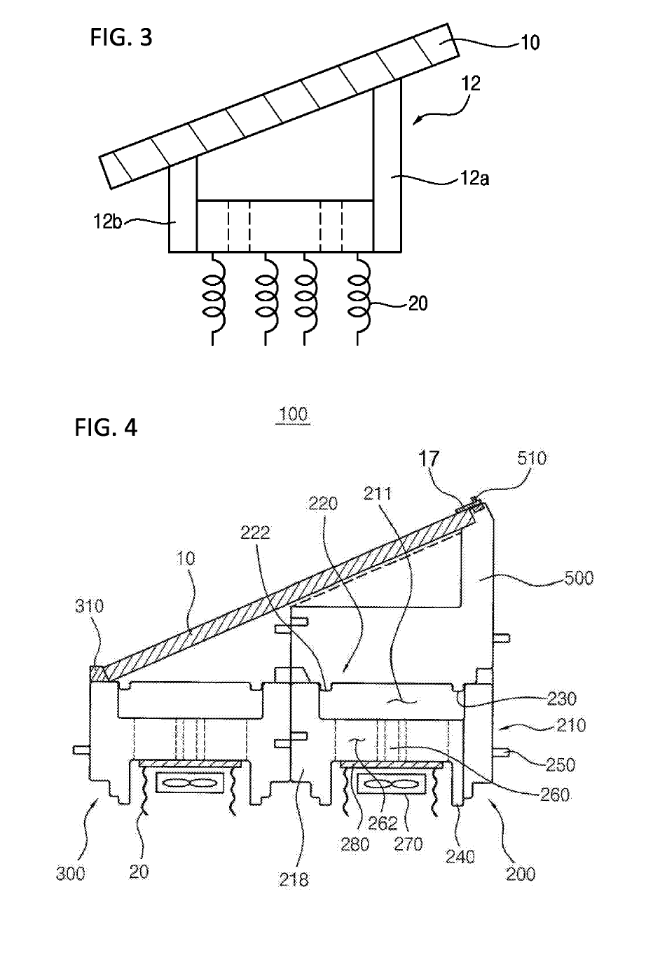

The solar power generation unit 15 will be explained later with reference to FIGS. 3 and 4.

The air blowing unit 14 is disposed adjacent to the aeration tank 13. The air blowing unit 14 supplies the air including the oxygen in the aeration tank 13. Also, the air blowing unit 14 may receive the electric power from the solar power generation unit 15 to be operated. Meanwhile the air blowing unit 14 may receive the electric power from a unit different from the solar power generation unit 15.

The air blowing unit 14 may be prepared under the aeration tank 13, and include an air supply line prepared under the aeration tank 13 to supply the air and a discharge nozzle extended from the air supply line to discharge the air toward an upper portion of the aeration tank.

Also, the air blowing unit 14 may additionally supply the air to the flow-rate regulation tank 11 or the settling tank 18.

The water purification apparatus according to the embodiment of the present invention may further include the settling tank 18. The settling tank 18 is connected to the aeration tank 13 to precipitate a portion of the purified fluid, that is the active sludge, supplied from the aeration tank 13. Thus, the active sludge including the aerobic bacteria may be back supplied in the aeration tank 13. As a result, the aerobic bacteria supplied in the aeration tank 13 may be used to purify the polluted fluid. The fluid purified from the settling tank 18 is provided to a wet land and passes through the wet land, and is finally discharged.

The water purification apparatus according to the embodiment of the present invention may further include a vegetation structure 19.

The vegetation structure 19 may be prepared in the flow-rate regulating tank 11, the aeration tank 13, the settling tank 18, or the wet land. Here, the vegetation structure 19 is floatably stacked so that vegetation may grow.

Meanwhile, the vegetation structure 19 may include a plurality of unit bodies (shown in FIGS. 3 and 4) included in the solar power generation unit. Thus, size and shape of the vegetation structure may be easily changed by assemblage and dissemblage of the unit bodies. Water may be supplied to the vegetation structure using a pump 19a.

A wet layer may be formed in each of the unit bodies. Thus, a plurality of vegetation may grow in the wet layer.

Meanwhile, a contact filter may be prepared in the unit body. Thus, the vegetation structure may purify the polluted fluid through a trickling filter method. According to the trickling filter method, fluid is sprayed on the contact filter such as crushed rock covered by a mucous membrane, a media layer, etc., so that the bio membrane makes contact with organic material in the polluted water. Here, a slime layer mainly includes bacteria, protozoan, fungi, etc., and higher animals such as sludge bug, maggot, rotifer, etc., may exist. However, when the trickling filter process is performed through the stacked structure of the unit bodies, generation of the maggot may be prevented. Thus, process times of the water purification process using the aeration tank and the water purification process using the trickling filter are controlled to prevent the generation of the maggot.

FIG. 3 is a cross-sectional view illustrating one embodiment of a panel supporting part which supports a solar power generation unit of FIG. 1.

Referring to FIG. 3, the panel supporting part 12 is prepared to support the solar power generation unit. The panel supporting part 12 includes supporting walls 12a and 12b having different heights, so that a solar battery panel 10 included in the solar power generation unit may be inclined and supported.

Meanwhile, a media bio-membrane 20 such as textile may be prepared under the panel supporting part 12.

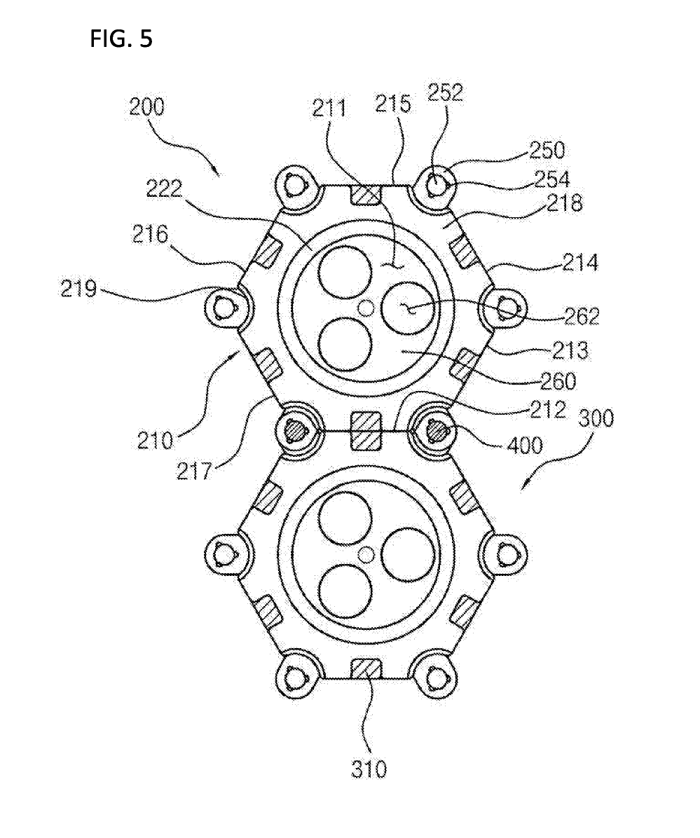

FIG. 4 is a cross-sectional view illustrating another embodiment of a panel supporting part which supports a solar power generation unit of FIG. 1. FIG. 5 is a cross-sectional view illustrating unit bodies forming the panel supporting part of FIG. 3.

Referring to FIGS. 4 and 5, the panel supporting part includes a first unit body 200, a second unit body 300, a connecting member 400, and an inclined supporting body 500.

The first and second unit bodies 200 and 300 have substantially the same structure, and each of the first and second unit bodies 200 and 300 includes polygonal faces 210, 1 supporting plate 220, a first combining part 230, a second combining part 240, and a connecting protrusion 250.

The polygonal faces 210 include six vertical flat surfaces 212, 213, 214, 215, 216, and 217 which are connected to each other in a vertical direction to form a hollow 211 formed in a center to pass through top and bottom. In particular, the polygonal faces 210 may have a column structure, and in the embodiment of the present invention, hexagonal pillar will be explained. Thus, the first and second unit bodies 200 and 300 have a structure at which any one of the vertical flat surfaces 212, 213, 214, 215, 216, and 217 makes face contact.

Also, the polygonal faces 210 may have a jacket part 218, in which floatable material such as air which is floatable on water, so that the jacket part 218 may float on the water. Thus, an assembly 100 of the present invention may be amphibiously used through the jacket part 218.

The supporting plate 220 is formed on the polygonal faces 210 to support the solar battery panel 10. Here, the supporting plate 220 supports the inclined supporting body 500, which will be explained later in detail, to slantly support the solar battery panel 10. Thus, the supporting plate 220 may include a guide groove 222 to guide position of the inclined supporting body 500 to securely support the inclined supporting body 500. Here, the guide groove 222, for example, may have a circular shape as shown in FIG. 3.

The first combining part 230 is formed in a groove shape on the polygonal faces 210. In this case, the first combining part 230 may be substantially the structure of the guide groove 222 of the supporting plate 220. Alternatively, the first combining part 230 may be formed in a protrusion shape protruded from an upper surface of the polygonal faces 210.

The second combining part 240 may have an opposite shape to the first combining part 230 to be combined with the first combining part 230 under the polygonal faces 210. In particular, the first combining part 230 may be formed in the recess shape or the protrusion shape, and the second combining part 240 may be formed in the protrusion shape or the recess shape. Then, the first and second combining parts 230 and 240 are combined, so that a plurality of the first unit bodies 200 may be securely stacked, and thus, height of the assembly 100 may be controlled, and storage and transportation may be securely and easily performed.

The connecting protrusions 250 are prepared to protrude from the polygonal faces 210 in a horizontal direction which is perpendicular to the vertical direction. In particular, the first and second unit bodies 200 and 300 have the structure in which any one of the vertical flat surfaces 212, 213, 214, 215, 216, and 217 makes fact contact with each other, and thus, the connecting protrusions 250 may be prepared to be protruded from edges of the polygonal faces 210 so that the connecting protrusions 250 are not interfered by the face contacting vertical flat surface 212. Here, a recess groove 219, which is inwardly recessed to prevent interference by size of the connecting protrusions 250, may be formed on the edges of the polygonal faces 210. By the structure of the connecting protrusions 250, the connecting protrusions 250 are combined with each other at both edges of the face contacting vertical flat surfaces 212 when the first and second unit bodies 200 and 300 are assembled. Here, the connecting protrusions 250 combined with each other may be protruded so that an upper surface of one of the connecting protrusions 250 and a lower surface of another one of the connecting protrusions 250 equal to a predetermined height of the first and second unit bodies 200 and 300, so that the assembled first and second unit bodies 200 and 300 have the same height. A connecting recess 252 may be formed to pass through each of the connecting protrusion 250 in the vertical direction.

The connecting member 400 connects the connecting protrusions 250 combined at both edges of the face contacted vertical flat surface 212, so that the first and second unit bodies 200 and 300 are assembled while any one of the vertical flat surface 212 makes face contact with each other. In particular, the connecting member 400 passes through the connecting recess 252 formed through the combined connecting protrusions 250 to connect the above. Hereinafter, referring again to FIG. 4, a structure in which the connecting member 400 is inserted into and combined with the connecting recess 252 of the combined connecting protrusions 250 will be explained in detail.

Also, the first and second unit bodies 200 and 300 may further include a bottom part 260 formed in the hollow 211. A throughhole 262 may be formed through the bottom part 260 an up and down direction. Thus, when the assembly 100 in which the first and second unit bodies 200 and 300 are assembled is installed on a common soil, external air may naturally ventilate through the throughhole 262, so that an environment in which vegetation grow eco-friendly may be prepared. However, when the assembly 100 is disposed in a floating state on the sea through the jacket part 218 of the polygonal faces 210, the throughhole 262 partially absorbs resistance caused by tides generated from the sea to prevent damage thereof. Also, when the assembly 100 is installed on a wet land, nutrients are supplied from the wet land through the throughhole 262, so that the wet layer (not shown) providing eco-friend atmosphere may be formed.

Meanwhile, each of the first and second unit bodies 200 and 300 may further include an agitating part 270 to generate convection phenomenon on a lower portion of the bottom part 260. Then, performance of the air flow of the external air, the resistance of the tide, and the supply of the nutrients from the wet land through the throughhole 262 may be improved through the agitating part 270.

As shown in the drawings, the agitating part 270 may be disposed on each of the first and second unit bodies 200 and 300. Alternatively, the agitating part 270 may be installed on only one of the first and second unit bodies 200 and 300.

Also, each of the first and second unit bodies 200 and 300 may further include an attaching part 280 on which textile is attached under the bottom part 260 to generate microorganisms. When the assembly 100 assembled by the first and second unit bodies 200 and 300 are installed on waterside such as the wet land in which pollution is highly probable, water may be naturally purified through the microorganisms generated from the media bio-membrane 20 attached to the attaching part 280.

The inclined supporting body 500 is assembled with the guide groove 222 formed on the supporting plate of the first unit body 200. The inclined supporting body 500 slantly supports the solar battery panel 10 in Korea having latitude of about 38 degrees so that the solar battery panel 10 is exposed in a direction perpendicular to the sunlight.

Thus, the second unit body 300 may include a stopper 310 to prevent the solar battery panel 10 supported by the inclined supporting body 500 from being dislocated from the inclined supporting body 500. Here, the second unit body 300 has substantially the same structure so that the second unit body 300 may be substituted by the first unit body 200, and thus, the stopper 310 may be formed on the first unit body 200 although the stopper 310 does not perform the function thereof. For example, the stopper 310 may be formed in a ‘C’ shape to be coupled with one side portion of the solar battery panel in a clip type.

Also, the inclined supporting body 500 may include a fixing part 510 combined and fixed with a clip at an end portion of the solar battery module 10 to slantly fix the solar battery panel 10. Here, the fixing part 510 may have a protrusion shape on which the clip 17 is hung, and may include a combining structure of nut and bolt, thereby easily dissemble and assemble by requirement.

Also, the fixing part 510 has the ‘C’ shape so that one side portion of the solar battery panel 10 may be coupled in a clip type.

The unit body of the assembly 100 supporting the solar battery panel 10 includes the polygonal faces 210 having the six vertical flat surfaces 212, 213, 214, 215, 216, and 217 connected to each other in the vertical direction. Thus, when one of the vertical flat surfaces 212 makes face contact, a portion is formed on left and right sides thereof, so that an external impact or a stress generated by expansion and shrinkage caused by temperature change may be dispersed to the formed space. Therefore, breakage of the unit body caused by concentration of the stress may be prevented.

The water purification apparatus of the embodiment of the present invention may further include a global positioning system, a solar tracking apparatus, and a propelling body.

The global positioning system is disposed on the panel supporting part to check position of the panel supporting part.

The solar tracking apparatus calculates position of the sun based on season, date, time, longitude, latitude based on position information of the panel supporting part received from the global positioning system.

The propelling body is installed on the panel supporting part. The propelling body is prepared to change position and direction of the panel supporting part based on the position of the sun calculated by the solar tracking apparatus. The propelling body, for example, may include a propeller.

The water purification apparatus of the present invention includes the solar generation unit, so that the air blowing unit is operated by a self-power using the electric power charged by the solar power generation, and direction is changed based on position of the sun. Thus, efficiency of the solar power generation is excellent.

Also, the water purification apparatus of the present invention is capable of vegetation, and shape and size may be easily controlled by assemblage and dissemblage of a unit body.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A water purification apparatus comprising:
a flow-rate regulating tank changing flow-rate of polluted fluid to constantly discharge;
an aeration tank purifying the fluid using microorganisms by contacting the polluted fluid supplied from the flow-rate regulating tank to an air, and including a floatable panel supporting part and a purifying part connected under the panel supporting part to purify the polluted fluid;
a solar power generation unit supported by the panel supporting part to generate electric power using sunlight; and
an air blowing unit receiving the electric power from the solar power generation unit to supply the air in the aeration tank.

2. The water purification apparatus of claim 1, wherein the purifying part comprises a media bio-membrane connected to a lower part of the panel supporting part and including a media.

3. The water purification apparatus of claim 1, wherein the purifying part comprises carbon fiber purifying the polluted fluid.

4. The water purification apparatus of claim 1, wherein the air blowing unit comprises:
an air supply line prepared under the aeration tank to supply the air; and
a discharge nozzle connected to the air supply line to discharge the air on an upper portion of the aeration tank.

5. The water purification apparatus of claim 1, further comprising:
a global positioning system (GPS) installed on the supporting part to check position of the panel supporting part;
a solar tracking apparatus calculating semester, date, time, longitude, and latitude based on position information of the supporting part received from the global positioning system; and
a propelling body installed on the panel supporting part to change position and direction of the supporting part based on position of the sun calculated by the solar tracking apparatus.

6. The water purification apparatus of claim 1, wherein the panel supporting part comprises a plurality of unit bodies, and each of the unit bodies includes:
hexagonal faces including vertical flat surfaces connected with each other in a vertical direction;
a module panel supporting part formed on the hexagonal faces to support the solar battery module;
a first combining part formed to have a protrusion or a recess on the hexagonal faces;
a second combining part formed under the hexagonal faces in an opposite shape to the first combining part to be combined with the first combining part; and
a plurality of combining protrusions protruded from each of edges between the hexagonal faces in a horizontal direction perpendicular to the vertical direction, and
wherein the combining protrusions are disposed on recess grooves inwardly recessed from the edges, respectively.

7. The water purification apparatus of claim 1, further comprising a settling tank connected to the aeration tank to precipitate a portion of the purified fluid supplied from the aeration tank, and
wherein the settling tank supplies active sludge to the aeration tank.

8. The water purification apparatus of claim 1, further comprising a vegetation structure disposed in the flow-rate regulating tank, the aeration tank, or the settling tank, and floatably stacked to grow vegetation.
